(19) United States
(12) Patent Application Publication
(10) Pub. No.: US 2012/0278236 A1
(43) Pub. Date: Nov. 1, 2012

(54) SYSTEM AND METHOD FOR PRESENTMENT OF NONCONFIDENTIAL TRANSACTION TOKEN IDENTIFIER

(75) Inventors: Nikhil Jain, San Diego, CA (US); Jose R. Menendez, San Diego, CA (US)

(73) Assignee: QUALCOMM INCORPORATED, San Diego, CA (US)

(21) Appl. No.: 13/278,996

(22) Filed: Oct. 21, 2011

Related U.S. Application Data
(63) Continuation-in-part of application No. 13/052,611, filed on Mar. 21, 2011.

(51) Int. Cl. G06Q 20/40

(52) U.S. Cl. 705/44

(57) ABSTRACT

A method and system for completing a purchase transaction includes receiving the non-confidential number to effect a purchase transaction from a caller identifier and requesting that a value account associated with the non-confidential number be debited, wherein the debit amount is associated with the purchase transaction. A request for authorization is transmitted to an operator of at least one of portable computing device and a landline phone, wherein the request seeks authorization to debit the value account. The at least one value account may comprise a credit account in which the telephone number may form part of the primary account number (PAN) governed by the ISO/IEC 7812 card number standard.

### STATEMENT REGARDING RELATED APPLICATION

This application is a continuation-in-part of and claims priority under 35 U.S.C. §120 to U.S. Non-provisional patent application Ser. No. 13/052,611, filed on Mar. 21, 2011, entitled, “SYSTEM AND METHOD FOR PRESENTMENT OF NONCONFIDENTIAL TRANSACTION TOKEN IDENTIFIER,” the entire contents of which are hereby incorporated by reference.

### BACKGROUND

Noncash tender types are commonplace in today's society. Consumers routinely participate in transactions for purchasing goods and services by providing merchants with payment tokens which may be associated with any number of account types. “Credit card” tokens associated with secured or unsecured lines of credit and “gift card” or “debit card” tokens associated with stored value accounts are common examples of noncash tender used in today's marketplace.

Issuers of payment tokens usually employ from thirteen to sixteen digits to create an account number for use on a payment token (i.e., a token number), although token numbers for some issuers may be more or less than the thirteen to sixteen digit range. For some of the larger token issuers, sixteen digits are commonly used, wherein the first six digits of the token number form the issuer identifier (including the initial digit which also serves to identify the major industry with which the issuer is associated, such as banking, travel, petroleum, etc.). For a sixteen digit token number, the nine numbers following the initial six used to form the issuer identifier portion will represent a user's individual account identifier. Notably, the number of digits associated with the individual account identifier may vary according to the total number of digits required to form a token number for a given issuer. The final digit in a typical sixteen digit token number is usually referred to as the check digit or the “checksum” digit and may be used to confirm the validity of the previous digits in the token number via application of a verification algorithm (commonly, the “Luhn” algorithm). This algorithm may minimize the success rate of casual attempts to create a valid token number as well as prevent manual entry mistakes at a point of sale (“POS”) terminal.

Token numbers are inherently confidential and must be safeguarded, lest the number be misappropriated by an unauthorized user. As such, current systems and methods do not provide for the use of a non-confidential token number. Further, current systems and methods do not provide for the use of a non-confidential number to complete a purchase transaction against a value account associated with the user of the non-confidential number, wherein the non-confidential number is additionally associated with the user for a public purpose other than a purchase transaction. Also, current systems and methods do not provide for the use of a single, non-confidential number to complete a purchase transaction against any one of a plurality of value accounts associated with a single user. Even further, current systems and methods do not provide for the use of a non-confidential number within the existing infrastructure controlled by a confidential payment token issuer.

Accordingly, what is needed is a system and method for leveraging a non-confidential number, such as a number associated with a user for a purpose unrelated to a value account, to effect purchase transactions against a value account or accounts associated with a user. Accordingly, what is also needed is a system and method for leveraging a non-confidential number to effect purchase transactions via an existing network configured for confidential account numbers.

### SUMMARY OF THE DISCLOSURE

A method and system for completing a purchase transaction via presentment of a non-confidential account number includes associating at least one value account with a primary account number comprising a non-confidential number, wherein the value account is associated with a user and the non-confidential number is associated with a telephone account of a user. The telephone account may comprise a landline account or a cellular telephone account. The method includes receiving the non-confidential number to effect a purchase transaction from a caller identifier and requesting that a value account associated with the non-confidential number be debited, wherein the debit amount is associated with the purchase transaction. A request for authorization is transmitted to an operator of at least one of portable computing device and a landline phone, wherein the request seeks authorization to debit the value account. The at least one value account may comprise a credit account, also known to one of ordinary skill in the art as a credit card account. The telephone number may form part of the primary account number (PAN) governed by the ISO/IEC 7812 card number standard.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a high level diagram illustrating exemplary components of a system for leveraging a non-confidential number associated with a portable computing device to effect purchase transactions against a value account or accounts associated with the user of the portable computing device.

FIG. 2 is a functional block diagram illustrating exemplary aspects of a portable computing device that may be included in the FIG. 1 system.

FIG. 3 illustrates an exemplary method for leveraging, via an existing card network controlled by a third party issuer, a non-confidential number to effect purchase transactions against a value account or accounts associated with a user.

FIG. 4 illustrates an exemplary method for leveraging a unique tender type associated with a non-confidential number to effect purchase transactions against a value account or accounts associated with a user.

FIG. 5 is a diagram of exemplary computer architecture for the system of FIG. 1.

FIG. 6 is a diagram of an exemplary, non-limiting aspect of a portable computing device comprising a wireless telephone which corresponds with FIG. 2.

FIG. 7A is a diagram of an exemplary, non-limiting payment token including a non-confidential number suitable for routing through an existing card network controlled by a third party issuer.

FIG. 7B is a diagram of an exemplary, non-limiting payment token including a non-confidential number suitable for routing through an existing card network controlled by a third party issuer.

FIG. 7C is a diagram of an exemplary, non-limiting payment token including a non-confidential number suitable for routing directly to a network associated with a selected tender type.

FIG. 8A is a high level diagram illustrating exemplary components of a system for leveraging a non-confidential number associated with a portable computing device OR a landline phone via a caller identifier to effect purchase transactions against a value account or accounts associated with the user of the portable computing device OR the landline phone.

FIG. 8B is a diagram similar to FIG. 8A but includes further examples of merchants who may benefit from leveraging a non-confidential number associated with a portable computing device OR a landline phone via a caller identifier to effect purchase transactions against a value account or accounts.

FIG. 9 illustrates an exemplary method for leveraging, via an existing card network controlled by a third party issuer, a non-confidential number via a caller identifier (“Caller ID”) to effect purchase transactions against a value account or accounts associated with a user.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed. Further, an “application” may be a complete program, a module, a routine, a library function, a driver, etc.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device” and “wireless handset” are used interchangeably. With the advent of third generation (“3G”) and fourth generation (“4G”) wireless technology, greater bandwidth availability has enabled more portable computing devices with a greater variety of wireless capabilities. Therefore, a portable computing device (“PCD”) may include a cellular telephone, a pager, a PDA, a smartphone, a navigation device, a tablet personal computer (“PC”), or a hand-held computer with a wireless connection or link.

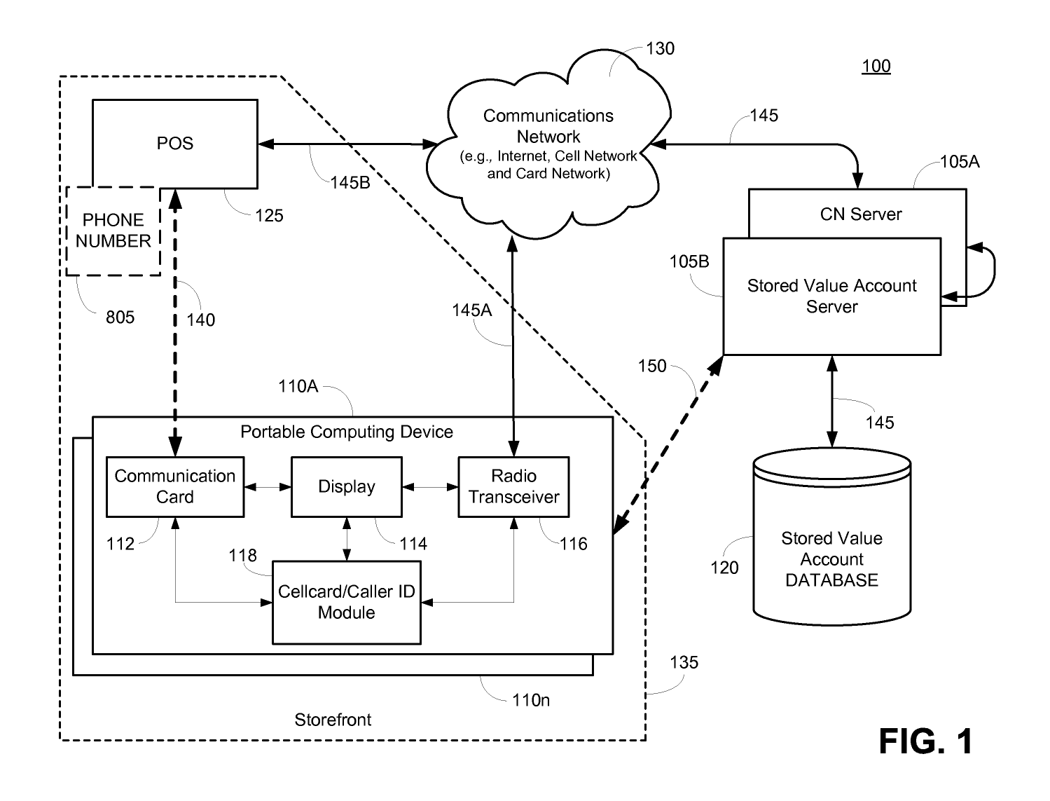

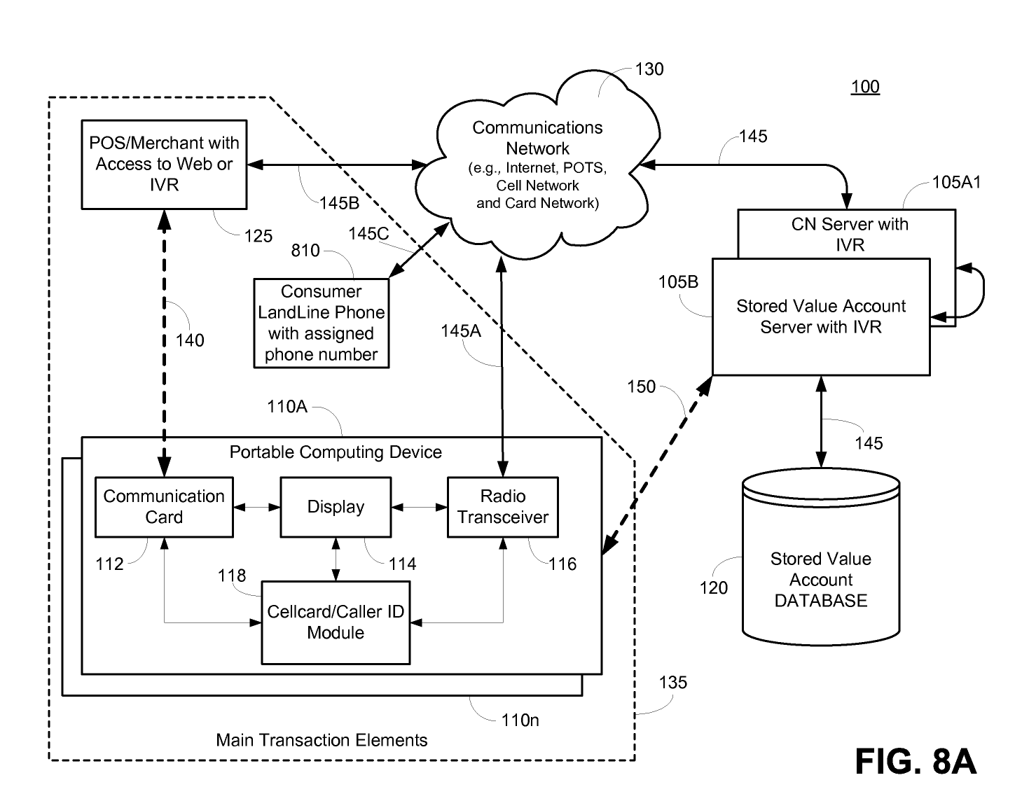

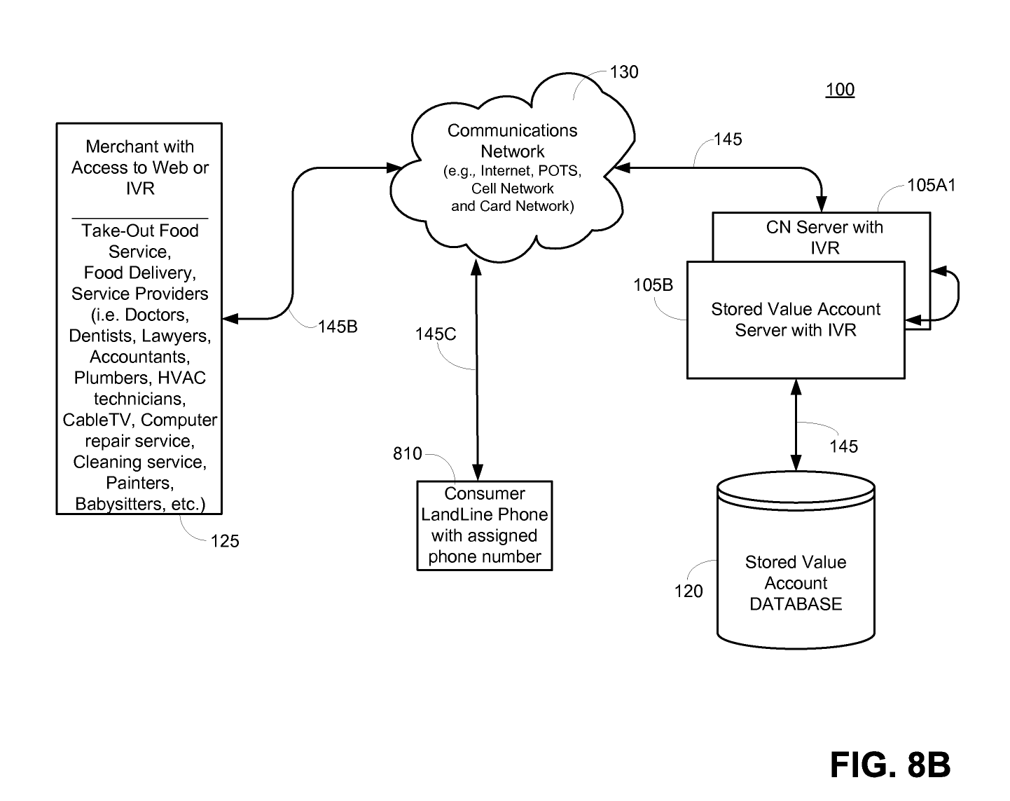

Referring to FIG. 1, depicted is a high level diagram illustrating exemplary components of a system 100 for leveraging a non-confidential number associated with PCD 110A (and in a later embodiment, a non-confidential number associated with a landline phone 810 as illustrated in FIGS. 8A-8B) to effect purchase transactions against a value account or accounts associated with the user of PCD 110A. The illustrated components of an exemplary system 100 include PCD 110 grouped in a storefront 135 with a merchant POS terminal or register (or a merchant with access to the Internet, interactive voice response—IVR system, etc. as illustrated in FIGS. 8A-8B) 125. It is envisioned that a merchant POS terminal or register (or a merchant with access to the Internet, interactive voice response—IVR system, etc. as illustrated in FIGS. 8A-8B) 125 may be any component, application or system operable to receive data in payment for goods or services such as, but not limited to a cash register, a desktop computer, a laptop computer, a personal digital assistant, a tablet computer, a scanner, a cellular “smart” phone, a landline phone using the plain old telephone system (“POTS”), or the like.

Importantly, while storefront 135 may be a physical “brick and mortar” location in some embodiments, it is envisioned that other embodiments may include a virtual storefront 135 for purchase transactions, such as a website or telecommunication, or a remote location relative to the operator of the PCD 100A (or operator of the landline phone 810 as illustrated in FIGS. 8A-8B), wherein the PCD 110 (or the operator of the landline phone 810) and the merchant are not physically co-located.

Leveraging system 100 to employ a non-confidential number associated with the user of PCD 110A (or a landline phone 810 illustrated in FIGS. 8A-8B) to effect purchase transactions has many useful applications. Briefly, and to provide the basis for an exemplary, non-limiting application scenario in which aspects of some embodiments of the disclosed systems and methods may be suitably described, consider a non-confidential number, such as a wireless phone number assigned to a PCD 110A, or phone number assigned to a landline phone 810, being associated with a plurality of value accounts. The plurality of value accounts may include any combination of credit accounts and/or stored value accounts (e.g., merchant-specific gift card accounts). The wireless phone number/landline phone number and plurality of value accounts are all tied to the user of PCD 110A. To further the example, a merchant establishment, whether virtual or physical, may be represented by storefront 135.

A user associated with PCD 110A (or a landline phone 810 of FIGS. 8A-8B) desires to purchase goods and/or services from the merchant's store 135 with a portable computing device 110A running a “cellcard” module 118 (or using a landline phone 810 of FIGS. 8A-8B). The goods and/or services are selected for purchase from the merchant associated with POS 125 (or a merchant with access to the Internet or an IVR as illustrated in FIGS. 8A-8B). The merchant “rings up” the goods for purchase, provides a purchase total to the user and asks for a payment method.

As is known to one of ordinary skill in the art, the user may select any number of payment methods including, but not necessarily limited to, cash, credit, gift card, debit card, etc. Notably, with the exception of payment by cash, which is essentially anonymous, each of the conventional methods of payment require the user to provide the merchant with confidential, or pseudo-confidential, data. In one exemplary scenario illustrated in FIG. 1, however, the user associated with PCD 110A selects payment by “cellcard number” and provides the merchant with the non-confidential, publicly available phone number associated with PCD 110A. It should be understood that the use of the term “cellcard number” does not limit the present disclosure to the use of a phone number, or even a number which includes a phone number, as a non-confidential number suitable to be leveraged for a purchase transaction. Rather, the term “cellcard number” is meant to encompass any non-confidential number tied to one or more value accounts, whether such accounts are credit accounts or stored value accounts, and, as such, the term “cellcard number” will not limit the scope of the disclosure to a phone number.

In another exemplary scenario illustrated in FIGS. 8A-8B, the operator of a landline phone 810 may select the payment method which uses the non-confidential, publicly available phone number associated with the landline phone 810 by retrieving this number from a caller identification (“Caller ID”) device/system. This scenario may also work if the operator of a PCD 110A uses his or her cellular phone number that is retrieved from the Caller ID system. This method may be referred to as payment by Caller ID. The exemplary embodiment illustrated in FIGS. 8A-8B will be described in further detail below.

Returning to the exemplary embodiment illustrated in FIG. 1, in the exemplary scenario depicted, the merchant enters the cellcard number into POS 125 as the selected means for payment. Alternatively, the operator of the PCD 110A may dial a phone number 805 associated with the POS 125 using a PCD 110A or a landline phone 810. This phone number (originating from either the PCD 110A or a landline phone 810) may be supported by the credit network (“CN”) server 105A1. The CN server 105A1 may retrieve the cellcard number from the Caller ID and relay it back to the POS 125.

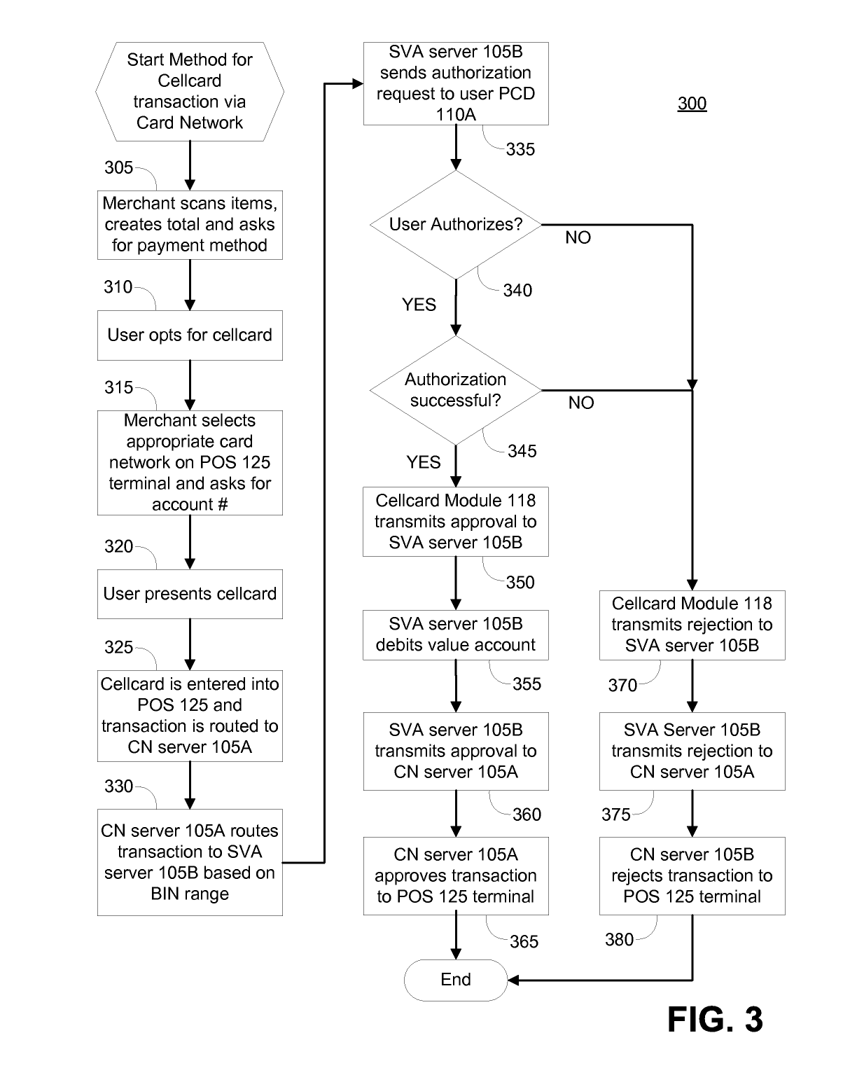

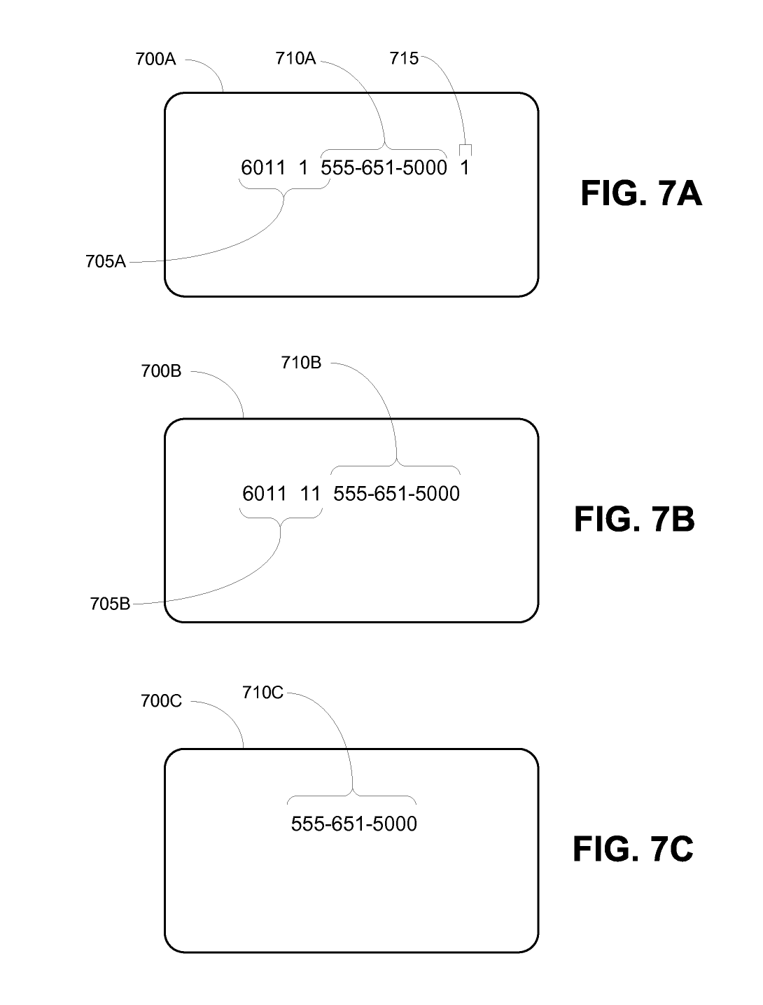

Notably, it is envisioned that some embodiments will leverage existing infrastructure configured for the conventional entry of confidential account numbers, wherein the cellcard number may include the phone number of the PCD 110A as well as additional numbers such as IIN numbers, a checksum, etc. These additional numbers may be provided by the operator of the PCD 110A (or a landline phone 810 or PCD 110A as illustrated in FIGS. 8A-8B). Alternatively, these additional numbers may be the same for a given account type and may be automatically generated by the POS 125 or at a server 105 based on the account type. For example, all VISA™ brand or MASTERCARD™ brand credit card accounts may utilize the same additional numbers that form a primary account number (“PAN”) as will be described in connection with FIG. 7. It is also envisioned that other embodiments will include a tender type selection at the POS configured specifically for the receipt of a cellcard number. Similarities and differences between various embodiments that may or may not leverage existing infrastructure will be described in more detail relative to FIGS. 3, 4 and 7A-7B.

Specifically regarding entry of the cellcard number into POS 125, the cellcard number may be provided verbally to the merchant in some embodiments while, in other embodiments, the cellcard number may be provided directly to the POS 125 via wireless communication link 140 or by the CN server 105 capturing the Caller ID associated with the PCD 110A when the PCD 110A dials a phone number 805 associated with the POS 125.

Regardless, once the cellcard number or Caller ID has been captured, it may be transmitted to the server 105, along with data specific to the purchase transaction which may include additional numbers forming the cellcard number or Caller ID associated with the account, via a communications network 130. As noted previously, the server 105 may provide the additional numbers beyond the cellcard number or Caller ID to form the PAN (as illustrated in FIG. 7).

If the cellcard number is configured for capture at the POS 125 via a tender type associated with existing infrastructure, such as via a card network associated with an issuer of typical confidential payment tokens (e.g., credit card issuers), the cellcard number may be initially routed to card network (“CN”) server 105A before being forwarded to stored value account (“SVA”) server 105B.

With respect to SVA server 105B, it may be a server, or servers, configured for the provision and management of accounts associated with a non-confidential payment token, such as a cellcard number, and, as such, it will be understood that the term “stored value account server” is not intended to limit accounts associated with a non-confidential payment token to be of a stored value nature. That is, it is envisioned that accounts managed by SVA server 105B may, in fact, be stored value accounts, such as gift card accounts or debit accounts, but may also be secured or unsecured credit accounts.

Once the cellcard number and associated purchase transaction data are received at SVA server 105B, the cellcard number may be queried for associated value accounts in stored value account database 120. Again, the value accounts associated with the cellcard number may be of a credit type or of a stored value account type. For the purpose of the exemplary scenario, however, suppose that a query of database 120 indicates that a gift card account associated with POS 125 (i.e., the merchant associated with POS 125) is also associated with the cellcard number. In such an embodiment, SVA server 105B may verify that there are sufficient funds in the gift card account to cover the purchase transaction. The SVA server 105B may then communicate with PCD 110A to seek authorization to debit the purchase transaction against the identified gift card account.

The communication with PCD 110A is accomplished via a link 145A back through network 130. PCD 110A may leverage cellcard module 118 to render the authorization request to the user of PCD 110A via display 114. The user may subsequently accept or decline the authorization to the server via actuation of an interface associated with cellcard module 118. If authorization is received by SVA server 105B from PCD 110A, then the exemplary gift card account may be debited in an amount identified by the purchase transaction data and confirmation of such debit transmitted back to POS 125, thus completing the transaction. If authorization is declined or otherwise not granted, confirmation of the decline is transmitted back to POS 125, thus terminating the payment of the purchase transaction by a cellcard number.

Concerning the various components depicted in the FIG. 1 illustration, exemplary embodiments of a PCD 110, such as the PCD 110A illustrated in system 100 envision remote communication, real-time software updates, extended data storage, etc. Advantageously, embodiments of PCDs 110 configured for communication via a computer system such as the exemplary system 100 depicted in FIG. 1 may leverage communications networks 130 including, but not limited to cellular networks, Public Switched Telephone Networks (“PSTNs”), plain old telephone system (“POTS”), interactive voice response (“IVR”) systems, cable networks, card issuer networks and the Internet for, among other things, software upgrades, content updates, database queries, data transmission, etc. Other data that may be useful in connection with a PCD 110, and accessible via the Internet or other networked system, are understood by one of ordinary skill in the art.

The illustrated computer system 100 may comprise a server 105 that may be coupled to a network 130 comprising any or all of a wide area network (“WAN”), a local area network (“LAN”), the Internet, or a combination of other types of networks. It should be understood that the term server 105 may refer to a single server system or multiple systems or multiple servers. The server 105 may be coupled to database 120, which may include a data/service database in addition to a stored value account database. The database 120 may store various records related to, but not limited to, device configurations, software updates, user's manuals, troubleshooting manuals, user-specific PCD configurations, PCD user-specific contact or account information, user-specific contact or account information, historical content, validation algorithms, filters/rules algorithms, audio/video data, etc.

When the server 105 is coupled to the network 130, the server 105 may communicate through the network 130 with various different PCDs 110 that may be comprised of desktop or laptop computers, thin clients, handheld devices such as personal digital assistants (“PDAs”), cellular telephones or other smart devices. Each PCD 110 may run or execute web browsing software or functionality to access the server 105 and its various applications. Any device that may access the network 130 either directly or via a tether to a complimentary device may be a PCD 110 according to the computer system 100. The PCDs 110, as well as other components within system 100 such as, but not limited to, a database server (not specifically depicted) associated with data/service database 120 or POS 125, may be coupled to the network 130 by various types of communication links 145.

These communication links 145 may comprise wired as well as wireless links The communication links 145 allow each of the PCDs 110 to establish virtual links 150 with the server 105. While a virtual link 150 is depicted between the server 105 and PCD 110A, an actual wireless link 140 may exist between the PCD 110A and the POS 125. This wireless link 140 may only be used to relay the cellcard number to the PCD 110A as a uni-directional communications channel. In other exemplary embodiments, the PCD 110A may establish bi-directional communications with the POS 125 as understood by one of ordinary skill in the art.

Each PCD 110 may include a display 114, wireless communication hardware 112, a radio transceiver 116 and a cellcard module 118. It is envisioned that the display 114 may comprise any type of display device such as a liquid crystal display (“LCD”), a plasma display, an organic light-emitting diode (“OLED”) display, a touch activated display, and a cathode ray tube (“CRT”) display, a brail display, an LED bank, and a segmented display. A PCD 110 may execute, run or interface to a cellcard module 118. The cellcard module 118 may comprise a multimedia platform that may be part of a plug-in for an Internet web browser.

The cellcard module 118 is designed to work with wireless communication hardware 112, a radio transceiver 116 and any stored or retrievable content to render a cellcard number and/or authorize a purchase transaction against an account associated with a cellcard number. When PCD 110A is leveraged within storefront 135, various content associated with the PCD user, cellcard number, cellcard number associated accounts and storefront 135 (including purchase transaction data) may be rendered on the display 114. Based on purchase transaction data, or other data, received by cellcard module 118, the cellcard module 118 may run one or more algorithms or processes required for validation/authentication of a purchase transaction prior to transmitting authorization to server 105.

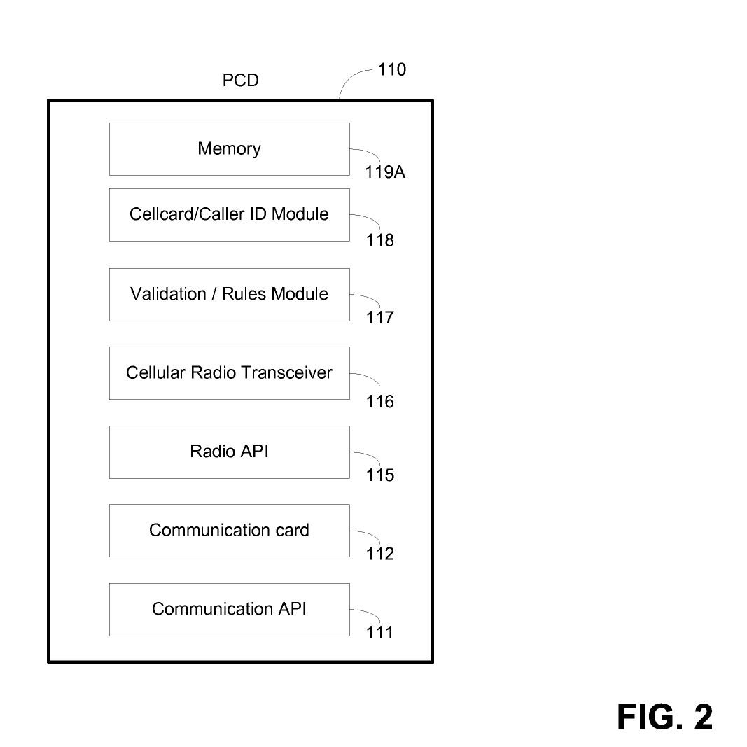

Referring to FIG. 2, an exemplary portable computing device 110 may comprise wireless communication hardware 112 such as, but not limited to, a WiFi card. The PCD 110 may also comprise a cellcard module 118 for receiving authorization requests or data requests from the wireless communication hardware 112 and/or the cellular radio transceiver 116 such as, but not limited to, non-confidential cellcard data and purchase transaction authorization requests. Wireless cellcard data transmitted by the wireless communication hardware 112 may have been requested from a geographically proximate transceiver device such as, but not limited to, an exemplary POS 125 as depicted in the system 100 of FIG. 1.

The cellcard module 118 may be configured to relay non-confidential cellcard information through wireless communication hardware 112 via a communication application programming interface (“API”) 111. As such, one of ordinary skill in the art will recognize that a cellcard module 118 may be designed to include the communication API 111 and/or wireless communication hardware 112 as part of its module in a unitary design. Further, the cellcard module 118 may be configured to interface with cellular radio transceiver 116, via a radio API 115 for receiving and transmitting purchase transaction authorization information as well as other information to exemplary server 105, as depicted in the system 100 embodiment. Even further, the cellcard module 118 may be configured to leverage a text to speech (“TTS”) module (not depicted) as may be known in the art to relay non-confidential cellcard information in an audible format, wherein the POS 125, or the merchant associated with POS 125, may recognize such an audible transmission. Thus, one of ordinary skill in the art will also recognize that a cellcard module 118 may also include the radio API 115 and/or cellular radio transceiver 116 and/or a TTS module as part of its module in a unitary design.

It is envisioned that a PCD 110 may be configured to leverage the cellular radio transceiver 116 to transmit data, such as a purchase transaction authorization, a personal identification number (PIN), a security key or other data generated by cellcard module 118. This data may be useful for verification of a geographical location or user identification by way of a secure channel using wireless link 145A to the server 105. It is also envisioned that PCDs 110 in some exemplary embodiments of system 100 may leverage communication link 145B via an unsecure or lesser secure wireless communication link 140 (relative to cellular wireless link 145A) that may be established between the POS 125 and PCD 110 to transmit data to and from server 105.

Wireless link 145A may comprise a secure channel established on a cellular telephone network. Moreover, communication links 145, in general, may comprise any combination of wireless and wired links including, but not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and a paging network.

The exemplary PCD 110 may also comprise a Validation/Rules module 117 for, among other things, automatically processing or filtering received authorization requests prior to accepting or declining a request to the server 105. Similarly, Validation/Rules module 117 or cellcard module 118 may provide user access restriction or other security measures to ensure that purchase transaction authorization is accepted or declined by a user of the PCD 110 authorized to do so. Because a Validation/Rules module 117 is not required in all PCDs 110, the presence or absence of a Validation/Rules module 117 in a PCD 110 will not limit the scope of the disclosure. Even so, it is envisioned that some embodiments of system 100 will include PCDs 110 comprising a Validation/Rules module 117. Advantageously, in embodiments which include a PCD 110 having a Validation/Rules module 117, an unauthorized user or purchase transaction may be recognized and/or filtered prior to communication with server 105.

An exemplary PCD 110 may also comprise a computer readable storage/memory component 119A for storing, whether temporarily or permanently, various data including, but not limited to, purchase transaction data and cellcard data as well as data added to, extracted or derived from cellcard data or accounts associated with a cellcard number. Data added to, extracted or derived from the purchase transaction data or cellcard data may comprise a user ID, a transaction ID, a directory number (“DN”) or calling line ID (“CLID”) associated with PCD 110, a merchant ID, a network name, a hash value, a codec key, encryption or decryption data, account numbers and other account related data such as, but not limited to, data related to an item being purchased, price of an item being purchased, purchase discount rates or amounts, customer loyalty data, sales tax rates or amounts, merchant employee identification, etc.

Referring to FIG. 3, illustrated is an exemplary method 300 for leveraging, via an existing card network controlled by a third party issuer, a non-confidential number to effect purchase transactions against a value account or accounts associated with a user of the PCD 110. Similar to the exemplary scenario offered above in connection with the FIG. 1 system, at block 305 a merchant scans or otherwise “rings up” items for purchase, creates a total for the purchase transaction, and asks the user of PCD 110A for a payment method.

Notably, while some embodiments may associate one or more value accounts with a cellcard number uniquely tied to a single PCD 110A user, it is envisioned that other embodiments may link multiple users of PCDs 110, i.e. a “family” of users of PCDs 110 (PCD 110A, PCD 110B, PCD 110C . . . PCD 110n), to common value accounts. Similarly, it is envisioned that multiple users of PCDs 110, who are linked to common value accounts, may be able to leverage individual non-confidential cellcard numbers or a single, common non-confidential cellcard number to effect purchase transactions against one or more associated value accounts. Further, it is envisioned that some embodiments which include a plurality of users of PCDs 110, who are each linked to one or more common value accounts, may provide for a purchase transaction authorization to be requested from only the user of PCD 110A or, for that matter, any subset of user of PCDs 110. That is, it is envisioned that some embodiments may provide for a purchase transaction to be initiated by a user of a PCD 110 other than the user of PCD 110A and then authorized by the user of PCD 110A. As a non-limiting example, a college aged child attending school on the west coast may provide a cellcard number for purchase of goods and the authorization request may be transmitted from server 105B to a PCD 110A associated with her father on the east coast.

Referring now to the FIG. 3 method 300 associated with the exemplary embodiment illustrated in FIGS. 1-2, at block 310 the PCD 110A user opts to remit payment via a non-confidential cellcard number having a format consistent with confidential payment token account numbers associated with third party issuer. Advantageously, unlike a typical purchase token uniquely linked to a credit account or stored value account, a cellcard number may include a number that is easily remembered and recited, as it may serve dual purposes as a transaction number and a phone number or the like. Moreover, as multiple value accounts may be associated with a single, non-confidential cellcard number, it is a further advantage that a user associated with a plurality of value accounts may only have to remember a single cellcard number in order to leverage each of the plurality of value accounts. The cellcard number may form part of an industry standard sixteen-digit payment number. Sixteen-digit payment numbers are understood by one of ordinary skill in the art as primary account numbers (“PANs”).

Each unique PAN comprising a phone number may also be referred to in the industry as a bank card number and is the primary account number found on most credit cards and bank cards. The PAN may be governed by an industry standard, such as those made by the International Organization for Standardization/International Electrotechnical Commission (“ISO”)/(“IEC”). The PAN may have a certain amount of internal structure and it may share a common numbering scheme among all PANs issued by existing third party card networks.

One particular standard for the PAN, as of this writing, may include the ISO/IEC 7812 standard. The ISO/IEC 7812 standard contains a single-digit Major Industry Identifier (“MII”), a six-digit Issuer Identification Number (“IIN”), an account number, and a single digit check sum calculated using the Luhn algorithm. The prefix of the PAN may be the sequence of digits at the beginning of the number that determine the credit card network to which the number belongs. As noted above, the first six digits of the PAN may be referred to as the Issuer Identification Number (“IIN”). These identify the institution that issued the card to the card holder. While the PAN may comprise a sixteen digit number, other multi-digit numbers as well as alphanumeric identifiers are within the scope of the system and method as described herein. Further details of the PAN will be described below in connection with FIG. 7A.

Referring back to FIG. 3, at block 315, the merchant selects payment by the card network of the third party issuer and requests the cellcard number. At block 320, the user of PCD 110A presents the cellcard number. It is envisioned that a cellcard number may be “presented” in any number of ways including, but not limited to, spoken presentation by the user, NFC or short wave radio transmission from a PCD 110 operable to do so, spoken presentation via a PCD 110 configured with a text to speech (“TTS”) module, the PCD 110 dialing a phone number 805 associated with the POS 125 and the cellcard number being retrieved from the Caller ID, etc. As such, while the means of cellcard number presentation may be a novel aspect of some embodiments of a system and method for leveraging a cellcard number, the particular means for presentation of a cellcard number will not limit the scope of the disclosure.

At block 325, the cellcard number is entered into/captured by the merchant POS 125 and then routed to the card network (“CN”) server 105A. Upon receipt of the cellcard data at CN server 105A, IIN data or other data encoded with the cellcard data causes the CN server 105A to forward the cellcard data to SVA server 105B at block 330.

At block 335, the SVA server 105B sends an authorization request to PCD 110A, requesting that the user of PCD 110A verify and authorize the purchase transaction. In some embodiments, the authorization request may cause cellcard module 118 to render data including, but not limited to, transaction total, date and time of transaction, merchant name and location, etc. At block 340, the user may authorize or decline the purchase transaction.

In some embodiments, it is envisioned that authorization or declination of a purchase transaction may require the user of PCD 110A to authenticate an identity or authorization clearance via the navigation of various security layers promulgated by cellcard module 118 and/or validation/rules module 117. Additionally, in some embodiments, it is envisioned that authorization of a purchase transaction will include selection by the user of an account associated with the cellcard. That is, as a cellcard may be associated with any number of value accounts, the purchase transaction authorization may require that the user select which account the purchase transaction should be debited against. Moreover, the cellcard module 118 and/or validation/rules module 117 may be configured to automatically select, in lieu of user selection at the time of authorization, one of a plurality of value accounts associated with a cellcard. Also, it is envisioned that some embodiments may include a “time out” feature such that, if a purchase transaction authorization is not received within a certain period of time, a purchase transaction may be automatically declined, deferred until authorization is received or a subsequent request for authorization is transmitted.

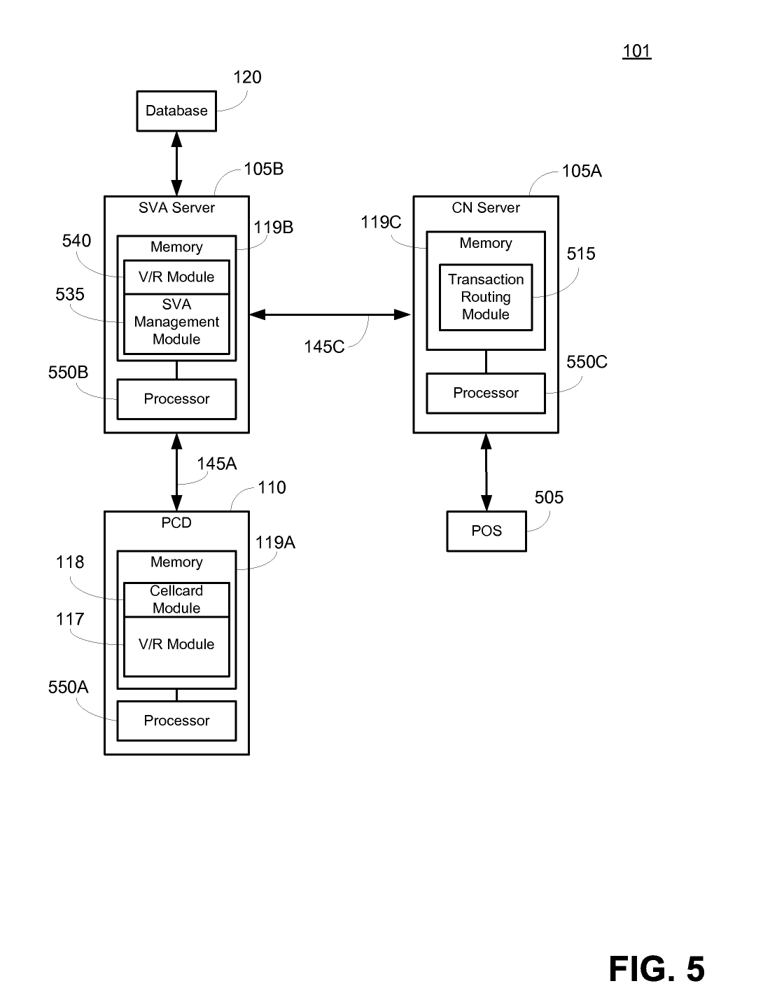

If the user of PCD 110A authorizes the purchase transaction at block 340, the authorization may be validated at block 345 via rules/validation module 117 running on PCD 110A or, alternatively, via a rules/validation module 540 running on server 105B (See FIG. 5). In some embodiments, an authorization that is not validated may cause a repeat authorization request (step not shown), while in other embodiments an authorization that is not validated may essentially terminate the transaction.

If the authorization is validated at block 345, at block 350 the cellcard module 118 may cause transmission of approval for the purchase transaction to server 105B. Upon receipt of purchase transaction approval, at block 355 server 105B may debit a value account associated with the cellcard number.

Notably, it is envisioned that in some embodiments, the SVA server 105B may determine the value account to be debited, from a plurality of value accounts associated with a cellcard number, by querying the location of a merchant POS 125 against value accounts associated with the merchant location. In such embodiments, data identifying the merchant POS 125 location may be transmitted from the POS 125 along with the purchase transaction data and cellcard data. Similarly, it is envisioned that some embodiments may leverage location data associated with a merchant POS 125 to automatically authorize the purchase transaction based on a comparison of global positioning system data (“GPS”) received from PCD 110A, or any other location system or method that may be known in the art such as, but not limited to, proximate cell tower identification, WiFi mac address maps, acoustic signature recognition, QR code recognition, etc., thus deducing that the user of PCD 110A is present at the POS 125 proximity.

Returning to the exemplary FIG. 3 method, at blocks 360 and 365 the SVA server 105B may transmit purchase transaction approval back to the merchant POS 125 via CN server 105A and the third party card network. After block 365, a purchase transaction has been effected by use of a non-confidential cellcard number and the method 300 ends. For embodiments which “ride” on an existing third party card network, one of ordinary skill in the art will recognize the advantage of leveraging existing infrastructure for the employment of a non-confidential cellcard number to effect purchase transactions.

Referring back to blocks 340 and 345, if purchase transaction authorization is not granted, or otherwise declined, at block 370 the cellcard module 118 may cause a rejection to be returned to SVA server 105B. Subsequently, server 105B may pass the purchase transaction rejection back to POS terminal 125 via CN server 105A and the card network, at blocks 375 and 380. Upon receipt and transmission of a purchase transaction authorization rejection back to POS 125, the purchase is declined, and no amount is debited against an associated value account and the method 300 ends.

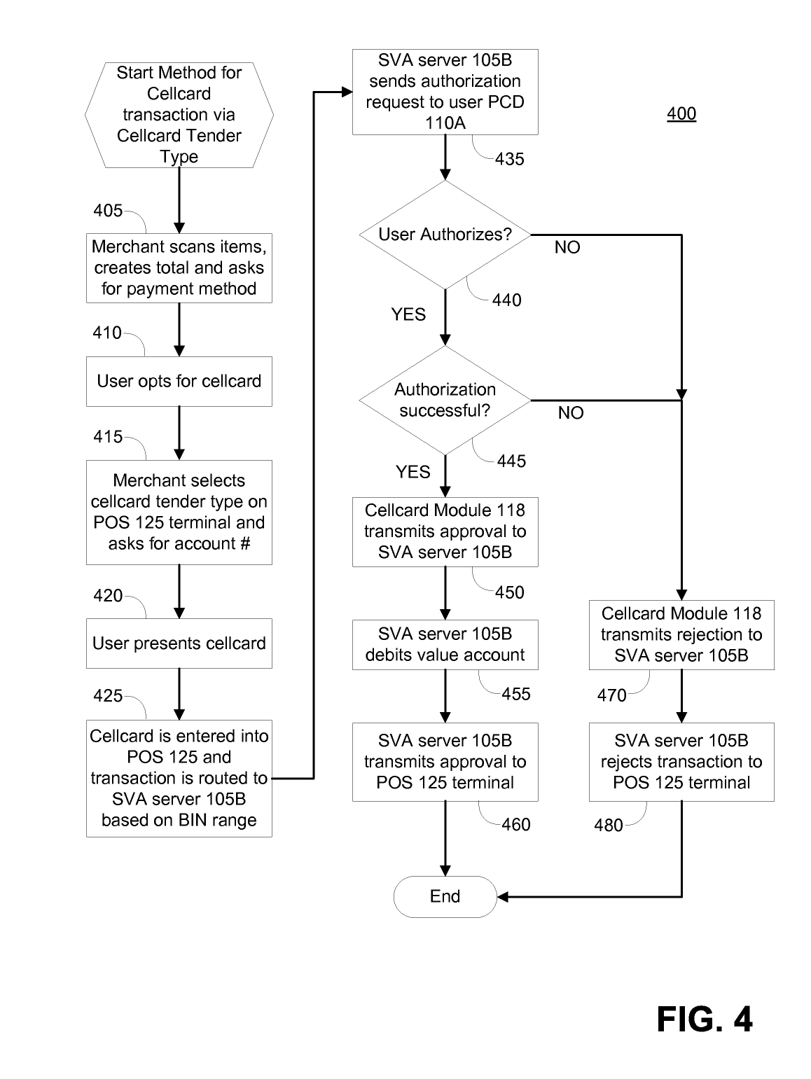

FIG. 4 illustrates an exemplary method 400, associated with the exemplary embodiment illustrated in FIGS. 1-2, for leveraging a unique tender type associated with a non-confidential number to effect purchase transactions against a value account or accounts associated with a user of a PCD 110. With the exception of actions performed by CN server 105B via a third party card network, the exemplary embodiment illustrated by method 400 essentially follows the exemplary embodiment described above relative to FIG. 3.

At block 405, a merchant creates a purchase transaction total and requests a payment method from the user of PCD 110A. Notably, in this embodiment and other embodiments, it will be understood that reference to the “user of PCD 110A” does not limit the scope of the disclosure to the provision of a cellcard number via the specific user of PCD 110A. That is, it is envisioned that other parties in possession of a non-confidential cellcard may provide the cellcard number for purchase of goods; however, one of ordinary skill will recognize that, unlike typical payment tokens known in the art, mere presentment of a cellcard number will not, in and of itself, authorize a purchase transaction as authorization for the transaction may be requested and validated only from the user of a predetermined PCD 110.

At block 410, the user of PCD 110A opts for payment by cellcard number. At block 415, the merchant selects at a POS register 125 a tender type uniquely associated with a cellcard token. Advantageously, in such an embodiment, the cellcard number may be rendered in a format not necessarily suitable for transmission across a third party issuer card network, as there is a tender type at the POS 125 configured for specific receipt of a cellcard number.

At block 420, the user of PCD 110A presents the cellcard number (i.e. providing a visual representation of the number, orally stating the number, dialing a phone number 805 associated with the POS 125 in which the cellcard number is extracted from the Caller ID, etc.) and, at block 425, the associated data is received by the POS 125 and routed along with the purchase transaction data directly to SVA server 105B. Subsequently, at block 435, the SVA server 105B sends an authentication request to PCD 110A. If the user of PCD 110A authorizes the purchase transaction at block 440, and such authorization is validated at block 445, the cellcard module 118 may transmit purchase transaction authorization back to SVA server 105B at block 450.

Upon receipt of authorization at block 450, at block 455 the SVA server may debit an associated account according to an amount identified by the purchase transaction data and at block 460 transmit approval of the purchase transaction back to POS 125, thus effecting a purchase by non-confidential cellcard number and ending the purchase by cellcard process.

Referring back to blocks 440 and 445, if authorization is rejected or otherwise not validated, at block 470 the cellcard module may decline authorization for the purchase transaction to the SVA server 105B. In such an event, at block 480 the SVA server 105B will transmit rejection of the purchase transaction to the POS 125, thus ending the purchase by cellcard process.

Turning now to FIG. 5, a diagram of exemplary computer architecture 101 for the system 100 of FIG. 1 is depicted. The exemplary architecture 101 may include a portable computing device (“PCD”) 110. An SVA server 105B may be connected to the PCD 110. The SVA server 105B may be connected to the PCD 110 via a wireless communications link 145A, such as a mobile telephone network. Further, the SVA server 105B may be connected to a CN server 105A via a direct communications link 145C, such as by a WAN. As noted previously, it should be understood that the term server 105 may refer to a single server system or multiple systems or multiple servers. One of ordinary skill in the art will appreciate that the various server arrangements may be selected depending upon computer architecture design constraints and without departing from the scope of the invention.

As illustrated in FIG. 5, the PCD 110 may include a processor 550A and a memory 119A coupled to the processor 550A. The memory 119A may include instructions for executing one or more of the method steps described herein. Further, the processor 550A and the memory 119A may serve as a means for executing one or more of the method steps described herein. As indicated, the memory 119A may also include a cellcard module 118 and/or a Validation and Rules (“V/R”) module 117. The cellcard module 118 and the V/R module 117 may be provided to the PCD 110 by the SVA server 105B.

A cellcard module 118 may operate to render a cellcard token and transmit the associated data to POS 125, according to various mechanisms described above relative to FIG. 1. Further, the cellcard module 118 may operate to receive purchase transaction authorization request from SVA server 105B and, subsequently, transmit acceptance or declination of such authorization back to SVA server 105B. A V/R module 117 operates to validate authorization actuations requested by the cellcard module 118 and/or automatically authorize purchase transactions based on the application of various heuristics. For example, V/R module 117 may apply heuristics to automatically authorize purchase transaction requests based on purchase amount, merchant identification, the ID of the PCD 110 associated with the purchase transaction, etc.

FIG. 5 shows that the SVA server 105B may include a processor 550B and a memory 119B coupled to the processor 550B. The memory 119B may include instructions for executing one or more of the method steps described herein. Further, the processor 550B and the memory 119B may serve as a means for executing one or more of the method steps described herein. As illustrated, the memory 119B may include a V/R module 540 operable to validate authorization transmissions received from the cellcard module 118 and/or automatically authorize purchase transactions based on the application of various heuristics. For example, V/R module 540 may apply heuristics to automatically authorize purchase transaction requests based on purchase amount, merchant identification, the ID of the PCD 110 associated with the purchase transaction, various data associated with the purchase transaction, etc. Further, as illustrated, the memory 119B may include an SVA management module 535 operable to query database 120 and update records associated with various value accounts tied to a given non-confidential cellcard token.

The V/R module 540 within the SVA server 105B may be similar to the V/R module 117 stored within the PCD 110. Further, the V/R module 540 within the SVA server 105B may include substantially the same logic as the V/R module 117 stored within the PCD 110. While a V/R module is not required in both a PCD 110 and SVA server 105B in all embodiments, it is envisioned that redundant filters and validation algorithms may be implemented across V/R modules 117, 540 in some embodiments. A database 120 for storage of V/R algorithms, content for dissemination, value account records, PCD user historical data, etc. may also be connected to the SVA server 105B.

Additionally, with regard to the V/R module 540 included in some embodiments of an SVA server 105B, it is anticipated that heuristics may be applied to guard against the theft of a PCD 110A or generally misappropriation of a cellcard token associated with PCD 110A. For example, a stolen PCD 110 may be rendered ineffective for the authorization of a purchase request via application of heuristics which include the provision of a PIN, automated call for verification via a security question, provision of a code or key, etc. Moreover, in the event that a PCD 110 cannot communicate with an SVA server 105B due to lack of data or voice coverage, the V/R module 540 may apply heuristics or rules which dictate that an alternative authentication method be leveraged such as, but not limited to, a voice call when data connectivity is unavailable, entry of a PIN or other security code via the POS 125, etc. Even further, in some embodiments the V/R module 540 may automatically authorize a purchase transaction based the amount of the transaction being below a predetermined threshold, the purchase transaction originating from a user's preferred merchant or any other heuristic that may occur to one with ordinary skill in the art.

As depicted in FIG. 5, a third party card network (“CN”) server 105A may include a processor 550C and a memory 119C coupled to the processor 550C. The memory 119C may include instructions for one or more of the method steps described herein. Further, the processor 550C and the memory 119C may serve as a means for executing one or more of the method steps described herein. As illustrated, the memory 119C may include a transaction routing module 515 operable to route cellcard data and purchase transaction data between a POS 125 and SVA server 105B. A merchant's point of sale (“POS”) system 125 may also be connected to the CN server 105A such that cellcard and purchase transaction data may be tracked and transmitted to the SVA server 105B.

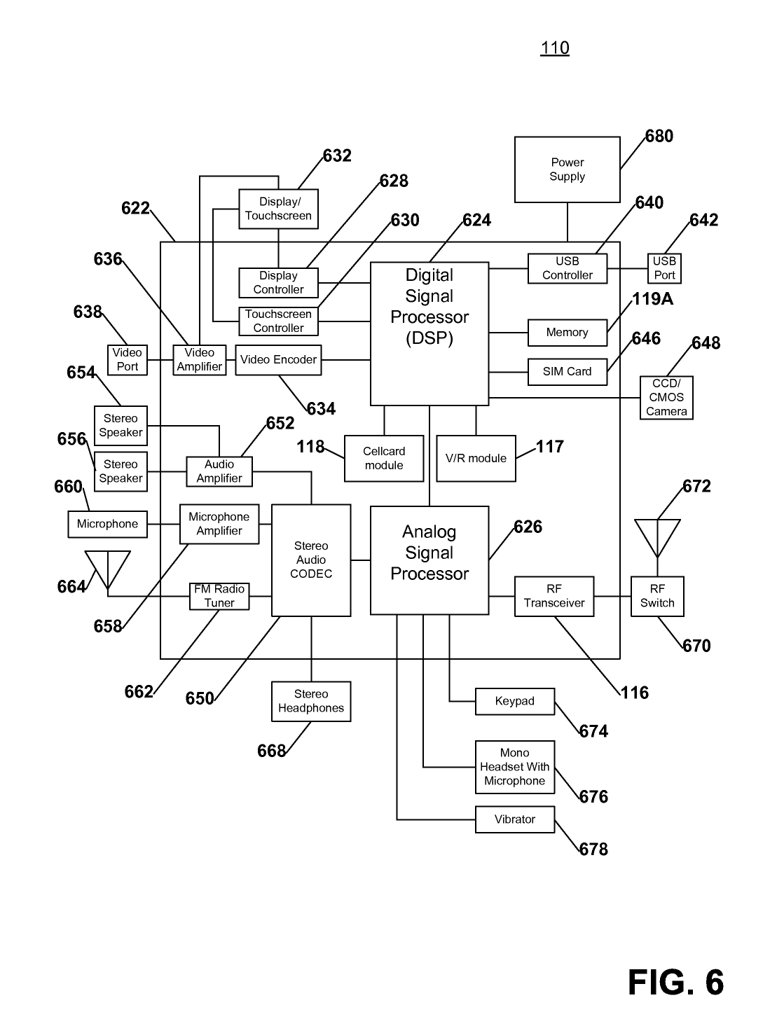

Referring to FIG. 6, this figure is a diagram of an exemplary, non-limiting aspect of a PCD 110 comprising a wireless telephone which corresponds with FIG. 2. As shown, the PCD 110 includes an on-chip system 622 that includes a digital signal processor 624 and an analog signal processor 626 that are coupled together. As illustrated in FIG. 6, a display controller 628 and a touchscreen controller 630 are coupled to the digital signal processor 624. A touchscreen display 114 external to the on-chip system 622 is coupled to the display controller 628 and the touchscreen controller 630.

FIG. 6 further indicates that a video encoder 634, e.g., a phase-alternating line (“PAL”) encoder, a sequential couleur avec memoire (“SECAM”) encoder, a national television system(s) committee (“NTSC”) encoder or any other video encoder, is coupled to the digital signal processor 624. Further, a video amplifier 636 is coupled to the video encoder 634 and the touchscreen display 114. A video port 638 is coupled to the video amplifier 636. A universal serial bus (“USB”) controller 640 is coupled to the digital signal processor 624. Also, a USB port 642 is coupled to the USB controller 640. A memory 119A and a subscriber identity module (“SIM”) card 646 may also be coupled to the digital signal processor 624. Further, a digital camera 648 may be coupled to the digital signal processor 624. In an exemplary aspect, the digital camera 648 is a charge-coupled device (“CCD”) camera or a complementary metal-oxide semiconductor (“CMOS”) camera.

As further illustrated in FIG. 6, a stereo audio CODEC 650 may be coupled to the analog signal processor 626. Moreover, an audio amplifier 652 may be coupled to the stereo audio CODEC 650. In an exemplary aspect, a first stereo speaker 654 and a second stereo speaker 656 are coupled to the audio amplifier 652. FIG. 6 shows that a microphone amplifier 658 may be also coupled to the stereo audio CODEC 650. Additionally, a microphone 660 may be coupled to the microphone amplifier 658. In a particular aspect, a frequency modulation (“FM”) radio tuner 662 may be coupled to the stereo audio CODEC 650. Also, an FM antenna 664 is coupled to the FM radio tuner 662. Further, stereo headphones 368 may be coupled to the stereo audio CODEC 650.

FIG. 6 further indicates that a radio frequency (“RF”) transceiver 116 may be coupled to the analog signal processor 626. An RF switch 670 may be coupled to the RF transceiver 116 and an RF antenna 672. As shown in FIG. 6, a keypad 674 may be coupled to the analog signal processor 626. Also, a mono headset with a microphone 676 may be coupled to the analog signal processor 626.

Further, a vibrator device 678 may be coupled to the analog signal processor 626. Also shown is that a power supply 680 may be coupled to the on-chip system 622. In a particular aspect, the power supply 680 is a direct current (“DC”) power supply that provides power to the various components of the PCD 110 requiring power. Further, in a particular aspect, the power supply is a rechargeable DC battery or a DC power supply that is derived from an alternating current (“AC”) to DC transformer that is connected to an AC power source.

FIG. 6 also shows that the PCD 110 may include a cellcard module 118 and/or a V/R module 117. The cellcard module 118 may communicate with the SVA server 105B to authorize purchase transactions against a value account associated with a non-confidential cellcard token and managed by SVA server 105B.

As depicted in FIG. 6, the touchscreen display 114, the video port 638, the USB port 642, the camera 648, the first stereo speaker 654, the second stereo speaker 656, the microphone 660, the FM antenna 664, the stereo headphones 668, the RF switch 670, the RF antenna 672, the keypad 674, the mono headset 676, the vibrator 678, and the power supply 680 are external to the on-chip system 622.

In a particular aspect, one or more of the method steps described herein may be stored in the memory 119A as computer program instructions, such as cellcard module 118 and V/R module 117. These instructions may be executed by the digital signal processor 624, the analog signal processor 626, or another processor, to perform the methods described herein. Further, the processors, 624, 626, the memory 119A, the instructions stored therein, or a combination thereof may serve as a means for performing one or more of the method steps described herein.

FIG. 7A is a diagram of an exemplary, non-limiting payment token 700A including a non-confidential number 710A suitable for routing through an existing card network controlled by a third party issuer. The exemplary payment token 700A may be a token which includes a non-confidential number 710A corresponding to a phone number associated with a PCD 110 or a landline phone 810. As has been described above, it is an advantage that the non-confidential number may be a phone number, or other number, easily remembered and uniquely associated with a user of a PCD 110 or a landline phone 810. The token 700A may comprise a physical card. In other exemplary embodiments, the payment token 700A may comprise a virtual or digital card that is rendered on the display 114 of the PCD 100A.

In the FIG. 7A embodiment, the exemplary phone number 710A is preceded by a six-digit Issuer Identification Number (“IIN”) 705A, wherein the last of the six digits may coincide with the first digit of a ten-digit phone number for the PCD 110. Notably, although the exemplary embodiment depicted in FIG. 7A includes a ten-digit phone number, it will be understood that other embodiments may include phone numbers, or other non-confidential numbers, that are less or more than ten digits in length. The last number 715 is a checksum number used for the application of the Luhn algorithm, or other algorithm, to validate the validity of a token number. Notably, by modifying the phone number 710A to include an IIN number 705A and checksum 715, one of ordinary skill in the art will recognize that a payment token may be created such that an existing third party issuer card network infrastructure, which is configured for processing sixteen-digit payment numbers may be leveraged. These sixteen-digit payment numbers are understood by one of ordinary skill in the art as primary account numbers (“PANs”).

Each unique PAN comprising the phone number 710A may also be referred to in the industry as a bank card number and is the primary account number found on most credit cards and bank cards. The PAN may be governed by an industry standard, such as those made by the International Organization for Standardization/International Electrotechnical Commission (“ISO”)/(“IEC”). The PAN may have a certain amount of internal structure and it may share a common numbering scheme among all PANs issued by existing third party card networks.

One particular standard for the PAN, as of this writing, may include the ISO/IEC 7812 standard. The ISO/IEC 7812 standard contains a single-digit Major Industry Identifier (“MII”), a six-digit Issuer Identification Number (“IIN”), an account number, and a single digit check sum calculated using the Luhn algorithm. The prefix of the PAN may be the sequence of digits at the beginning of the number that determine the credit card network to which the number belongs. As noted above, the first six digits of the PAN may be referred to as the Issuer Identification Number (“IIN”). These identify the institution that issued the card to the card holder. While the PAN may comprise a sixteen digit number, other multi-digit numbers as well as alphanumeric identifiers are within the scope of the system and method as described herein.

More specifically, the IIN 705A may be used by a CN server 105A to route the cellcard data and associated purchase transaction data to a SVA server 105B. Once received, the SVA server 105B may use the non-confidential PCD 110A phone number 710A to query and identify value accounts associated with the user of PCD 110A or a landline phone 810. The checksum number 715, though not necessarily required by SVA server 105B in order to effect a purchase transaction by cellcard token or a Caller ID, may be used to create the illusion of a valid third party issuer number so that the cellcard token data may be seamlessly transmitted through POS 125 and CN server 105A.

FIG. 7B is a diagram of an exemplary, non-limiting payment token 700B including a non-confidential number 710B suitable for routing through an existing card network controlled by a third party issuer. Similar to the exemplary payment token 700A, the cellcard payment token 700B includes an IIN number 705B and a non-confidential number 710B, such as a phone number, associated with a user of a PCD 110. However, unlike the 700A token, the exemplary 700B token may “force” the checksum digit to match the last digit in the non-confidential number 710B. As such, in the exemplary 700B embodiment, an IIN number 705B may be used to route the cellcard data and purchase transaction data without requiring that a digit be used to crossover between the last digit of the IIN and the first digit of the non-confidential number 710B.

Notably, by forcing the digit generally recognized as the checksum to match the last digit of non-confidential number 710B, various algorithms known in the art to expose invalid PANs, such as the Luhn algorithm, may not be completely applicable to cellcard numbers such as the exemplary 710B. Advantageously, however, as data entry mistakes or invalid cellcard numbers may be caught via the user request and authorization steps outlined above in connection with various embodiments, it is envisioned that embodiments designed to leverage non-confidential numbers without authentic checksums, or non-confidential numbers which are altogether unexpanded, may not require the application of “front-end” verification algorithms like the Luhn algorithm. Even so, it is also envisioned that embodiments configured to leverage cellcard numbers which do not include authentic checksums or are comprised of altogether unexpanded non-confidential numbers may employ a “front end” verification algorithm designed specifically for the given cellcard number format.

FIG. 7C is a diagram of an exemplary, non-limiting payment token 700C including a non-confidential number 710C suitable for routing directly to a network and SVA server 105B associated with a tender type selected at POS 125. Unlike the exemplary payment tokens 700A and 700B, this cellcard or Caller ID payment token 700C does not include an IIN number. Though it is envisioned that some embodiments of a cellcard or Caller ID payment token suitable for routing directly to SVA server 105B may include routing prefixes such as an IIN number, the exemplary cellcard payment token 700C only includes a non-confidential number 710C, such as a phone number, associated with a user of a PCD 110. Further, unlike the 700A and 700B tokens, the exemplary 700C token does not require a checksum digit or a digit crossover between the IIN and phone number. That is, because a merchant POS 125 may include a tender type selection uniquely associated with payment by cellcard number in some embodiments, there is no need to “trick” a third party issuer system into routing the cellcard data and purchase transaction data to an SVA server 105B. Rather, in the exemplary 700C embodiment, the cellcard number or Caller ID number 710C itself may be used to route the cellcard data and purchase transaction data directly to an SVA server 105B to trigger a request for authorization to debit a purchase transaction against an associated value account.

Like payment token 700A of FIG. 7A, the payment token 700B of FIG. 7B and 700C of FIG. 7C may comprise a physical card. In other exemplary embodiments, the payment tokens 700 may comprise a virtual or digital card that is rendered on the display 114 of the PCD 100.

Notably, FIGS. 7A, 7B and 7C are offered as exemplary cellcard or Caller ID token formats that may be used in various embodiments of the systems and methods described herein. It will be understood that the exemplary FIGS. 7A, 7B and 7C embodiments are offered for illustrative purposes only and will not be construed to limit the nature, format, content or length of a cellcard or Caller ID token number. One of ordinary skill in the art will recognize that any payment token which includes an account number or data that is non-confidential in nature may be leveraged as a cellcard payment token.

Referring now to FIG. 8A, this figure is a high level diagram illustrating exemplary components of a system 100′ for leveraging a non-confidential number associated with a portable computing device 110A OR a landline phone 810 via a caller identifier (“Caller ID”) to effect purchase transactions against a value account or accounts associated with the user of the portable computing device 110A OR the landline phone 810.

FIG. 8A has elements which are similar to those illustrated in FIG. 1. Therefore, only the differences between these two figures will be described below. According to this exemplary embodiment, an operator of a landline phone 810 or an operator of a PCD 110A may interact with a merchant by communication links 145 which may comprise a landline or a cellular telephone communication. A merchant 125 who is in a remote location relative to the operator of the landline phone 810 or PCD 110A and who has access to the Internet or an interactive voice response (“IVR”) system may process payment for goods and/or services using a caller ID associated with the landline phone 810 or PCD 110A.

The merchant 125 may key-in the caller ID or the merchant 125 may have a device or system, or a POS 125 that is integrated with a cellular telephone and/or landline which retrieves a caller ID when the operator of the PCD 110A or operator of the landline communicates with the merchant 125. According to one exemplary embodiment, the merchant 125 who is interacting with the operator of the landline phone 810 or the operator of the PCD 110A via a communication link 145, may be using a Portable Computing Device (PCD), like a smart phone, which has an application program that extracts the caller ID from the communication link 145 and uses that caller ID for processing a payment that is routed across the communications network 130 to the servers 105.

This exemplary embodiment illustrated in FIG. 8A operates very similarly to the exemplary embodiment illustrated in FIG. 1 once the caller ID has been extracted from the communication link 145. While it is envisioned that the extraction of the caller ID from the communication link 145 may be automated, in certain instances in which the caller ID is not available or the caller ID has been blocked by the operator of the landline phone 810 or PCD 110A, the operator may relay the phone number associated with the landline 810 or PCD 110A by speaking to the merchant during the communication link 145. The merchant 125 may relay the caller ID over the communication link 145 to the communications network 130 by an electronic communication or by communicating with an interactive voice response (“IVR”) system that may be supported by the servers 105.

Once the caller ID and transaction data has been routed by the merchant over the communications network 130 to the servers 105 either by an electronic communication or through the interactive voice response (“IVR”) system, the servers 105 may authorize the transaction by communicating directly with the portable computing device 110A such as by a text message, e-mail, or other electronic communication. Alternatively, the servers may authorize the transaction by using the IVR system to contact the operator 810 over the POTS which may be part of the communications network 130 which establishes the communication link 145C.

FIG. 8B is a diagram similar to FIG. 8A but includes further examples of merchants who may benefit from leveraging a non-confidential number associated with a portable computing device 110A OR a landline phone 810 via a caller identifier to effect purchase transactions against a value account or accounts. FIG. 8B has elements which are similar to those illustrated in FIG. 8A. Therefore, only the differences between these two figures will be described below.

The merchant 125 in this exemplary embodiment may comprise any service provider or product vendor who can communicate with the operator of the landline phone 810 with a landline phone or a portable computing device, like PCD 110A of FIG. 1. The merchant 125 may generally access the servers 105 over the medications that work 130 by either electronic communications or by a standard landline phone using an IVR system supported by the servers 105.

In this way, an operator of a landline telephone 810, such as a consumer residing in a home like a house or an apartment, may conduct transactions with remote located merchants 125. The merchants 125 may include, but is not limited to, take-out food service providers, food delivery service providers (usually from grocery chains), service professionals like doctors, dentists, lawyers, accountants, plumbers, HVAC technicians, cable TV repairpersons, computer repair service providers, cleaning service providers, painters, babysitters, and other similar merchants 125.

According to one exemplary scenario, an operator of a landline phone 810 may desire to order a pizza from a food delivery service provider (i.e. pizza delivery shop). When the operator of the landline phone 810 (or the operator of a portable PCD 110A) contacts the merchant 125 via a telephone communication link 145C, the merchant 125 may extract the caller ID associated with the phone call originating from the operator of the landline phone 810 (or PCD 110A). The operator of the landline phone 810, after making the pizza order, may tell the merchant 125 that his or her payment should be made with the caller ID system.

The merchant 125 may key-in the caller ID or the merchant 125 may have been integrated POS system that extracts the caller ID from the communication link 145B. Alternatively, the merchant 125 may conduct the phone call with the operator of the landline 810 (or operator of a first PCD 100) using a second PCD 110 that includes an application program for extracting the caller ID. The system 100′ then operates similarly to the system 100 illustrated in FIG. 1 once the phone number associated with the consumer has been secured. If a traditional landline phone 810 is being utilized by the operator, then the transaction may be verified by the servers 105 which may communicate with the PCD 110 of the operator if the PCD 110 is available or the server 105 may utilize an IVR system to contact the operator of the landline phone 810 after the transaction has been submitted by the merchant 125.

The system 100′ illustrated in FIG. 8B may be ideal for nontraditional merchants 125 that include babysitters, friends, and family who may wish to secure payment from an operator of a landline phone 810. For example, if the operator of the landline phone 810 needs a babysitter which becomes the merchant 125 in this scenario, then the operator of the landline phone 810 may simply telephone the babysitter (merchant 125) and tell the babysitter to charge the transaction to the operator's account associated with his or her caller ID. The babysitter 125 may use a landline phone 810 in combination with an IVR system supported by the servers 105 to complete the transaction or the babysitter 125 may utilize a PCD 110 that has a communication link 145B to the communications network 130.

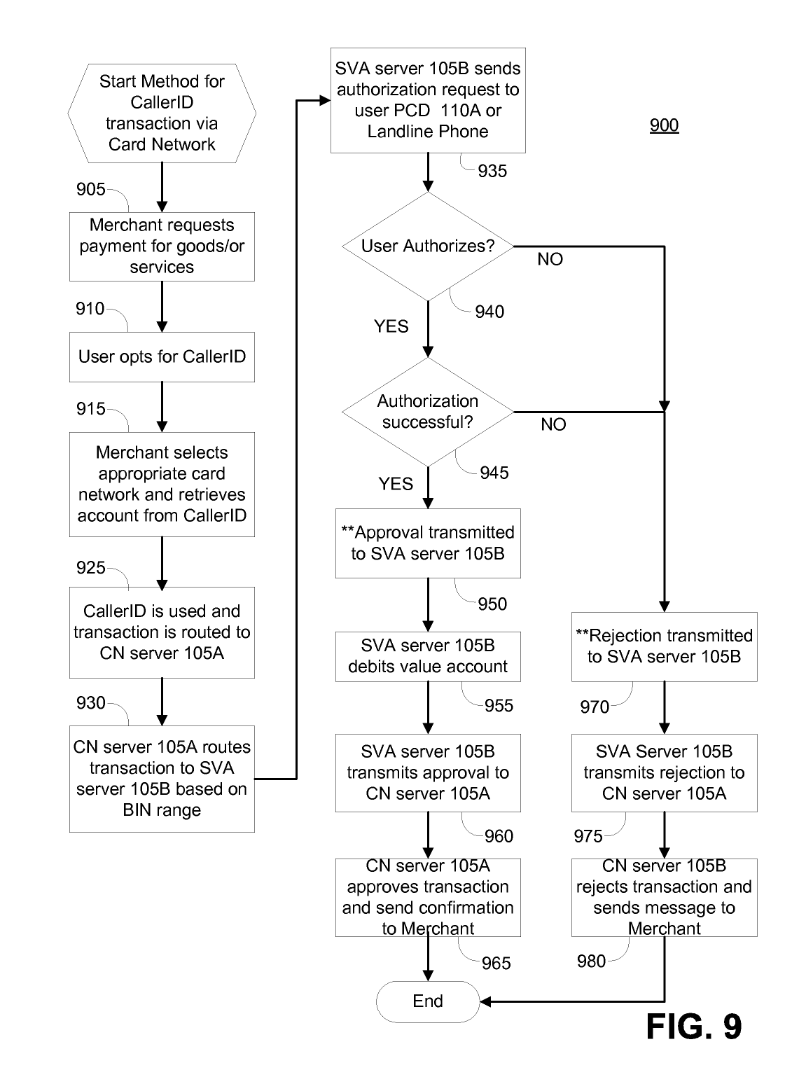

FIG. 9 illustrates an exemplary method 900 for leveraging, via an existing card network controlled by a third party issuer, a non-confidential number via a caller identifier to effect purchase transactions against a value account or accounts associated with a user. FIG. 9 has elements which are similar to those illustrated in FIG. 3. Therefore, only the differences between these two figures will be described below.

In method 900 associated with the exemplary embodiment illustrated in FIGS. 8A-8B, at block 905, the merchant 125 may request the operator of the landline phone 810 or a PCD 110 who may be in a remote location relative to the merchant 125 for payment to cover requested goods or services (or both). At block 910, the operator of the landline phone 810 or PCD 110A opts to remit payment via a non-confidential caller ID number having a format consistent with confidential payment token account numbers associated with third party issuer and which may be extracted from the caller ID of a communication link 145 between the merchant 125 and the operator of the landline phone 810 or a PCD 110A. Advantageously, unlike a typical purchase token uniquely linked to a credit account or stored value account, a caller ID, similar to the cellcard discussed above, may serve dual purposes as a transaction number and a phone number or the like. Moreover, as multiple value accounts may be associated with a single, non-confidential caller ID number, it is a further advantage that a user may use the single caller ID number in order to leverage each of the plurality of value accounts.

Like the cellcard number described above, the caller ID number may form part of an industry standard sixteen-digit payment number. Sixteen-digit payment numbers are understood by one of ordinary skill in the art as primary account numbers (“PANs”), such as illustrated in FIG. 7 described above. Each unique PAN comprising a phone number may also be referred to in the industry as a bank card number and is the primary account number found on most credit cards and bank cards.

At block 915, the merchant selects payment by the card network of the third party issuer and secures the caller ID number from the communication link 145.

At block 925, the caller ID number is captured by the merchant 125 (using a POS, a PCD 110, or by keying-in the caller ID) and then the caller ID is routed to the card network (“CN”) server 105A. Upon receipt of the caller ID data at CN server 105A, IIN data or other data encoded with the caller ID data causes the CN server 105A to forward the caller ID data to SVA server 105B at block 930.

The remaining blocks of method 900 are similar to the blocks of FIG. 3 except for block 930, block 950, and block 970. In Block 930, which is similar to Block 330 of FIG. 3, the SVA server 105 may send an authorization request to either a PCD 110 or a landline phone (or both). Block 950 which is similar to block 350 of FIG. 3 requires the operator of the landline phone 810 or the PCD 110A to send the approval for a transaction.

In the exemplary embodiment in which an operator uses a landline phone 810 to initiate payment for a transaction, if the operator also has a PCD 110A, the servers 105 may contact either the PCD 110A for approval or they may use an IVR system to ring the landline phone 810 for receiving an approval for the transaction. The servers could contact both devices (phone 810 or PCD 110), such as sending a message to the PCD 110 and calling phone 810 and authorizing the transaction if the user communicates by one of the devices. Block 970 may work similarly in which either the operator of a landline phone 810 or a PCD 110A may transmit a rejection for a particular transaction. In other words, the servers 105 may receive a rejection from the PCD 100A or a response to an IVR system initiated phone call to landline phone 810.

The landline phone system 100′ is not limited to the method 900 which illustrates leveraging an existing card network controlled by a third party issuer. The landline phone system 100′ may easily be used for leveraging a unique tender type associated with a non-confidential number, similar to FIG. 3, to effect purchase transactions against a value account or accounts associated with a user.

Certain steps or blocks in the processes or process flows described in this specification naturally precede others for the invention to function as described. However, the invention is not limited to the order of the steps or blocks described if such order or sequence does not alter the functionality of the invention. That is, it is recognized that some steps or blocks may performed before, after, or parallel (substantially simultaneously with) other steps or blocks without departing from the scope and spirit of the invention. In some instances, certain steps or blocks may be omitted or not performed without departing from the invention. Also, in some instances, multiple actions depicted and described as unique steps or blocks in the present disclosure may be comprised within a single step or block. Further, words such as “thereafter”, “then”, “next”, “subsequently”, etc. are not intended to limit the order of the steps or blocks. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, acoustic and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for completing a purchase transaction via presentment of a non-confidential account number, comprising:
associating at least one value account with a primary account number comprising a non-confidential number, wherein the value account is associated with a user and the non-confidential number is associated with a telephone account of a user;
receiving the non-confidential number to effect a purchase transaction from a caller identifier;
requesting that a value account associated with the non-confidential number be debited, wherein the debit amount is associated with the purchase transaction; and
transmitting a request for authorization to an operator of at least one of portable computing device and a landline phone, wherein the request seeks authorization to debit the value account.

2. The method of claim 1, further comprising the steps of:
authorizing the debit via the portable computing device or landline phone;
debiting the associated account; and
transmitting confirmation that the purchase transaction has been completed.

3. The method of claim 1, further comprising the steps of:
declining to authorize the debit via the portable computing device or landline phone; and
transmitting confirmation that the purchase transaction has been declined.

4. The method of claim 1, wherein the requesting step comprises transmission of the non-confidential account number and data associated with the purchase transaction over a communications network.

5. The method of claim 1, wherein a plurality of value accounts are associated with the single, non-confidential account number.

6. The method of claim 5, wherein the at least one value account is a stored value account uniquely associated with a merchant.

7. The method of claim 1, wherein the at least one value account is a credit account.

8. The method of claim 1, wherein the telephone number forms part of a primary account number (PAN) governed by a card number standard.

9. The method of claim 8, wherein the card number standard comprises ISO/IEC 7812.

10. The method of claim 1, wherein the non-confidential number is associated with a landline phone of the user.

11. A computer system for completing a purchase transaction via presentment of a non-confidential account number, the computer system comprising:
a processor operable for:
associating at least one value account with a primary account number comprising a non-confidential number, wherein the value account is associated with a user and the non-confidential number is associated with a telephone account of a user;
receiving the non-confidential number to effect a purchase transaction from a caller identifier;
requesting that a value account associated with the non-confidential number be debited, wherein the debit amount is associated with the purchase transaction; and
transmitting a request for authorization to an operator of at least one of portable computing device and a landline phone, wherein the request seeks authorization to debit the value account.

12. The system of claim 11, wherein the processor is further operable for:
authorizing the debit via the portable computing device or landline phone;
debiting the associated account; and
transmitting confirmation that the purchase transaction has been completed.

13. The system of claim 11, wherein the processor is further operable for:
declining to authorize the debit via the portable computing device or landline phone; and
transmitting confirmation that the purchase transaction has been declined.

14. The system of claim 11, wherein the processor is further operable for:
transmitting the non-confidential account number and data associated with the purchase transaction over a communications network.

15. The system of claim 11, wherein a plurality of value accounts are associated with the single, non-confidential account number.

16. The system of claim 15, wherein the at least one value account is a stored value account uniquely associated with a merchant.

17. The system of claim 11, wherein the at least one value account is a credit account.

18. The system of claim 11, wherein the telephone number forms part of a primary account number (PAN) governed by a card number standard.

19. The system of claim 18, wherein the card number standard comprises ISO/IEC 7812.

20. The system of claim 11, wherein the non-confidential number is associated with a landline phone of the user.

21. A computer system for completing a purchase transaction via presentment of a non-confidential account number, the system comprising:
means for associating at least one value account with a primary account number comprising a non-confidential number, wherein the value account is associated with a user and the non-confidential number is associated with a telephone account of a user;
means for receiving the non-confidential number to effect a purchase transaction from a caller identifier;
means for requesting that a value account associated with the non-confidential number be debited, wherein the debit amount is associated with the purchase transaction; and
means for transmitting a request for authorization to an operator of at least one of portable computing device and a landline phone, wherein the request seeks authorization to debit the value account.

22. The system of claim 21, further comprising:
means for authorizing the debit via the portable computing device or landline phone;
means for debiting the associated account; and
means for transmitting confirmation that the purchase transaction has been completed.

23. The system of claim 21, further comprising:
means for declining to authorize the debit via the portable computing device or landline phone; and
means for transmitting confirmation that the purchase transaction has been declined.

24. The system of claim 21, further comprising:
means for transmitting the non-confidential account number and data associated with the purchase transaction over a communications network.

25. The system of claim 21, wherein a plurality of value accounts are associated with the single, non-confidential account number.

26. The method of claim 25, wherein the at least one value account is a stored value account uniquely associated with a merchant.

27. The system of claim 21, wherein the at least one value account is a credit account.

28. The system of claim 21, wherein the telephone number forms part of a primary account number (PAN) governed by a card number standard.

29. The system of claim 28, wherein the card number standard comprises ISO/IEC 7812.

30. The system of claim 21, wherein the non-confidential number is associated with a landline phone of the user.

31. A computer program product comprising a computer usable medium having a computer readable program code embodied therein, said computer readable program code adapted to be executed to implement a method for completing a purchase transaction via presentment of a non-confidential account number, said method comprising:
associating at least one value account with a primary account number comprising a non-confidential number, wherein the value account is associated with a user and the non-confidential number is associated with a telephone account of a user;
receiving the non-confidential number to effect a purchase transaction from a caller identifier;
requesting that a value account associated with the non-confidential number be debited, wherein the debit amount is associated with the purchase transaction; and
transmitting a request for authorization to an operator of at least one of portable computing device and a landline phone, wherein the request seeks authorization to debit the value account.

32. The computer program product of claim 31, wherein the program code implementing the method further comprises:
authorizing the debit via the portable computing device or landline phone;
debiting the associated account; and
transmitting confirmation that the purchase transaction has been completed.

33. The computer program product of claim 31, wherein the program code implementing the method further comprises:
declining to authorize the debit via the portable computing device or landline phone; and
transmitting confirmation that the purchase transaction has been declined.

34. The computer program product of claim 31, wherein the requesting step comprises transmission of the non-confidential account number and data associated with the purchase transaction over a communications network.

35. The computer program product of claim 31, wherein a plurality of value accounts are associated with the single, non-confidential account number.

36. The computer program product of claim 35, wherein the at least one value account is a stored value account uniquely associated with a merchant.

37. The computer program product of claim 31, wherein the at least one value account is a credit account.

38. The computer program product of claim 31, wherein the telephone number forms part of a primary account number (PAN) governed by a card number standard.

39. The computer program product of claim 38, wherein the card number standard comprises ISO/IEC 7812.

40. The computer program product of claim 31, wherein the non-confidential number is associated with a landline phone of the user.
